(19) United States
(12) Patent Application Publication
(10) Pub. No.: US 2019/0337781 A1
(43) Pub. Date: Nov. 7, 2019

(54) Device for Transporting a Transported Good and Method

(71) Applicant: Kaup GmbH & Co. Gesellschaft für Maschinenbau, Aschaffenburg (DE)

(72) Inventor: Peter Schlott, Aschaffenburg (DE)

(21) Appl. No.: 16/466,736

(22) PCT Filed: Dec. 6, 2017
(86) PCT No.: PCT/DE2017/000413

§ 371 Date: Jun. 5, 2019

(30) Foreign Application Priority Data
Dec. 6, 2016 (DE) 10 2016 014 454.8

(51) Int. Cl. B66F 9/075; B66F 9/14

(52) U.S. Cl. CPC B66F 9/0755; B66F 9/143

(57) ABSTRACT

Apparatus (1) for transporting an item (2) for fitting on a lifting vehicle (3), in particular on a transporting device (3) of a fork-lift truck, comprising a means (4), in particular tines, for at least temporarily accommodating the item (2), also comprising an adjustment means for adjusting the means (4) for at least temporarily accommodating the item (2), to provide for parallel lateral adjustment, in particular of the tines, in the lateral direction (6), further comprising a control means (9) for controlling the functions of the add-on unit, wherein the control means is arranged, in particular, in the lifting vehicle, and additionally comprising a measuring means (7) for measuring a lateral displacement path (8) of the means (4) for at least temporarily accommodating the item (2), wherein, with the aid of the measurement by way of the measuring means (7), the lateral displacement path (8) is limited to a predetermined length (15) via the control means (9) and the adjustment means (5). A corresponding method for using the apparatus (1) for transporting an item (2) for fitting on a lifting vehicle (3).

### CROSS REFERENCE TO RELATED APPLICATIONS

This application is the U.S. national stage of International Application No. PCT/DE2017/000413, filed on 2017 Dec. 6. The international application claims the priority of DE 102016014454.8 filed on 2016 Dec. 6; all applications are incorporated by reference herein in their entirety.

### BACKGROUND

The invention concerns a device for transporting a transported good for attachment to a lifting vehicle, in particular to a transport device of a forklift truck, according to the generic term of claim 1 and a method for using a device for transporting a transported good according to the generic term of claim 11.

It is a well-known fact that safety regulations for lateral adjustment are fulfilled by cylinders with a specified extension width as lateral thrust adjustment.

The disadvantage is that the use of different cylinders is cost-intensive and only allows a standard length.

### SUMMARY

The invention involves a device for transporting a transported good for attachment to a lifting vehicle, in particular to a transport device of a forklift truck. Said device for transporting a transported good comprises a means, in particular tines, for at least temporarily receiving the transported goods, an adjusting means for adjusting the means for at least temporarily receiving the transported goods for parallel lateral adjustment, in particular of the tines in the lateral direction, a control means for controlling the functions of the attachment, the control means being arranged in particular in the lifting vehicle, and a measuring means for measuring a lateral traverse path of the means for at least temporarily picking up the transported goods. The lateral traverse path is limited to a predetermined length via the control means and the adjusting means with the aid of the measurement by means of the measuring means.

### DETAILED DESCRIPTION

The task of the present invention is to ensure simple, reliable handling of transported goods.

The problem is solved by a device for transporting a transport good for attachment to a lifting vehicle, in particular to a transport device of a fork lift truck, comprising a means, in particular tines, for at least temporarily receiving the transport good, an adjusting means for a lateral adjustment of the means for at least temporarily receiving the transport good in lateral direction, a measuring means for measuring a lateral traverse path of the means for at least temporarily receiving the goods to be transported, a control means for controlling the lateral traverse path by means of the adjusting means for a lateral adjustment, wherein, with the aid of the measurement by means of the measuring means, the lateral traverse path is to be limited to a predetermined length via the control means and the adjusting means.

The inventive device provides a very flexible device that can be adjusted to the respective transport situation and at the same time complies with the safety regulations and can be adapted to different lifting vehicles.

It is advantageous if the measuring instrument comprises a sensor medium, in particular a mechanical sensor and/or an electrical sensor and/or a hydraulic sensor.

It is advantageous, if the measuring means comprises a sensor means, that corresponding to an initial position and/or an end position of the lateral adjustment of the means and/or of the adjusting means for the lateral adjustment is provided.

It is advantageous if the measuring device comprises an integrated sensor device, in particular integrated into the control device and/or the adjustment device.

It is advantageous if the adjusting means for a lateral adjustment comprises a cylinder, in particular hydraulically and/or electrically and/or mechanically driven, wherein the cylinder is arranged in particular parallel to the lateral direction, wherein a control valve is arranged in particular in the lifting vehicle and/or in the device.

It is advantageous if two adjustment means are provided for a lateral adjustment, which in particular are arranged in opposite directions with opposite acting direction, whereby a parallel lateral adjustment can be achieved.

It is advantageous if the predetermined length for a parallel lateral adjustment is predetermined by a maximum carrying capacity of the means for transporting and/or a predetermined lifting height of the transported goods and/or the weight of the transported goods and/or a predetermined position of the means for at least temporarily receiving the transported goods.

It is advantageous if the control medium includes a magnetic control and/or micro-roSPS control.

It is advantageous if the lateral travel for one side is limited to a permissible size, in particular about 200 mm, in particular about 100 mm.

It is advantageous if the measuring and/or control equipment is located in the lift truck.

It is advantageous to use a method of using a device for transporting an item to be transported for attachment to a lifting vehicle according to one of claims 1 to 10, in particular to a transport device of a forklift truck, comprising a means, in particular prongs, for at least temporarily receiving the item to be transported, an adjusting means for adjusting the position of the means for at least temporarily receiving the item to be transported in the lateral direction, a measuring means for measuring a lateral traverse path of the means for at least temporarily receiving the transported goods, a control means for controlling the lateral traverse path by means of the adjusting means for a lateral adjustment, wherein the lateral traverse path is measured by means of the measuring means and is limited to a predetermined length via the control means and the adjusting means, wherein the predetermined length in particular depends on a predetermined lifting height and/or a weight of the transported goods and/or a position of the transported goods.

Further characteristics and advantages of the invention result from the claims and the following description, in which examples of the execution of the object of the invention are explained in connection with the drawings.

### BRIEF DESCRIPTION OF THE DRAWINGS

It shows

FIG. 1 a device for transport,

FIG. 2 a device for transporting on a lifting vehicle,

FIG. 3 A device for transporting on a lifting vehicle,

FIG. 4 a device for transporting on a lifting vehicle and

FIG. 5 a device for transporting on a lifting vehicle.

### DETAILED DESCRIPTION OF THE PREFERRED EMBODIMENTS

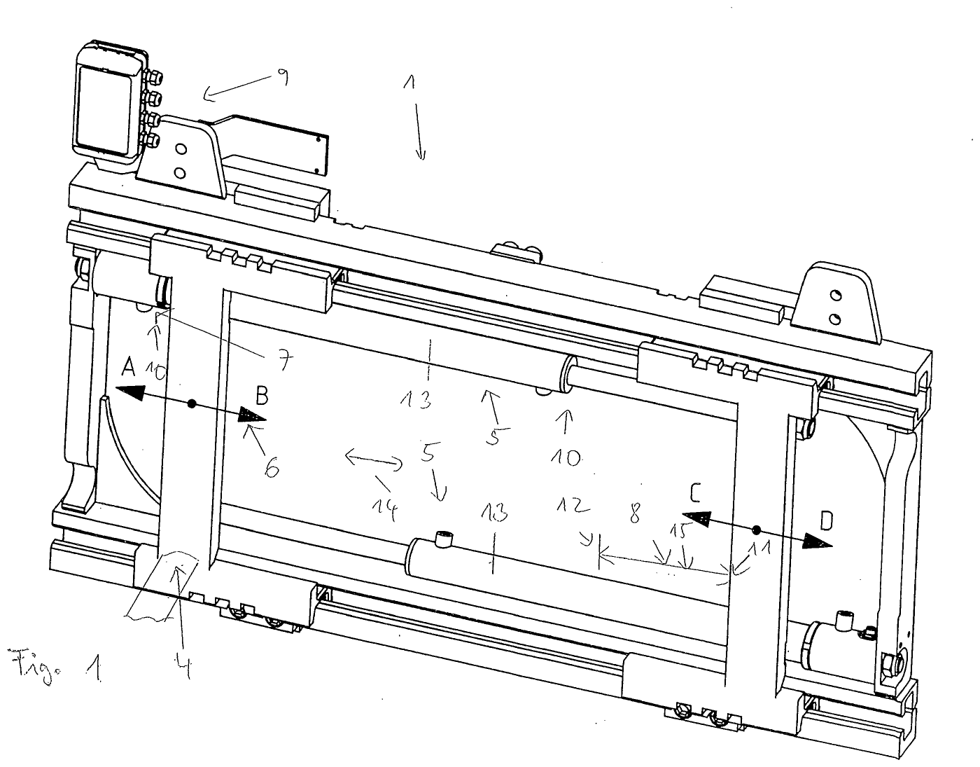

FIG. 1 shows a device 1 for attachment to a lifting vehicle 3, in particular to a transport device 3 of a fork-lift truck, for transporting a transported good 2, comprising a means 4, in particular prongs, for at least temporarily receiving the transported good 2, an adjusting means 5 for adjusting the position of the means 4 for at least temporarily receiving the transported good 2 in the lateral direction 6, for example AC or in the opposite direction BD, a measuring means 7 for measuring a lateral travel path 8 of the means 4 for at least temporarily picking up the goods to be transported 2, a control means 9 for controlling the lateral travel path 8 by means of the adjusting means 5 for a lateral adjustment, wherein, with the aid of measurement by means of the measuring means 7, the lateral travel path 8 is to be limited to a predetermined length 15 via the control means 9 and the adjusting means 5, wherein the lateral travel path is measured by means of the measuring means and is limited to a predetermined length via the control means and the adjusting means 5, wherein the predetermined length in particular depends on a predetermined lifting height and/or a weight of the transported goods and/or a position of the transported goods.

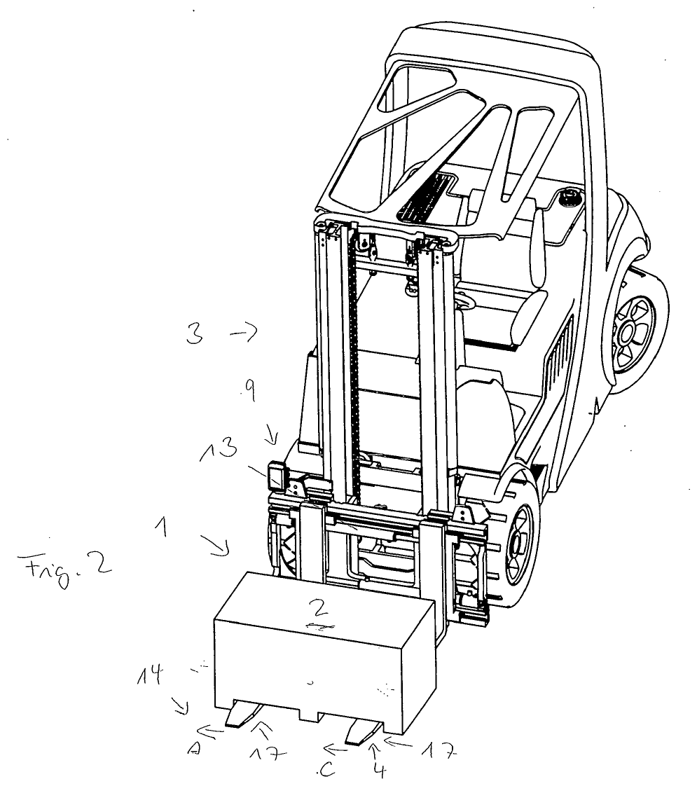

FIG. 2 shows a device 1 for transporting on a lifting vehicle 3, wherein an exemplary traverse direction 14 is predetermined, in which the means for at least temporarily picking up a material to be transported 2 with its two tines 17 is displaced in parallel. The control means 9 for this is attached to the device 1.

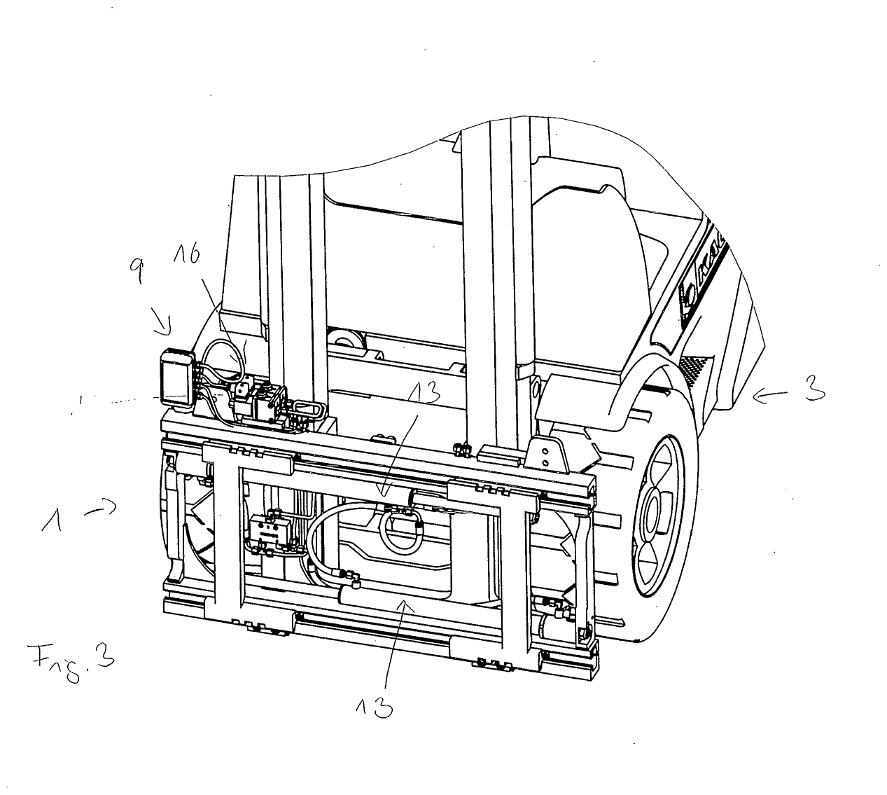

FIG. 3 shows a device 1 for transport on a lifting vehicle 3, the control means 9 and the valves 16 for the cylinders 13 being attached to the device 1.

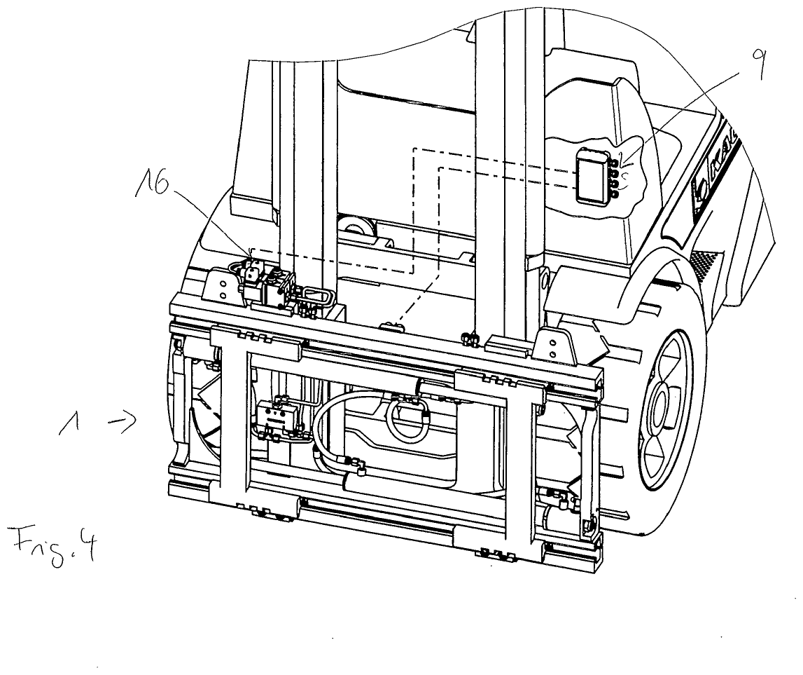

FIG. 4 shows a device 1 for transport on a lifting vehicle 3, the control means 9 being mounted in the lifting vehicle 3 and the valves 16 for the cylinders 13 being mounted on the device 1.

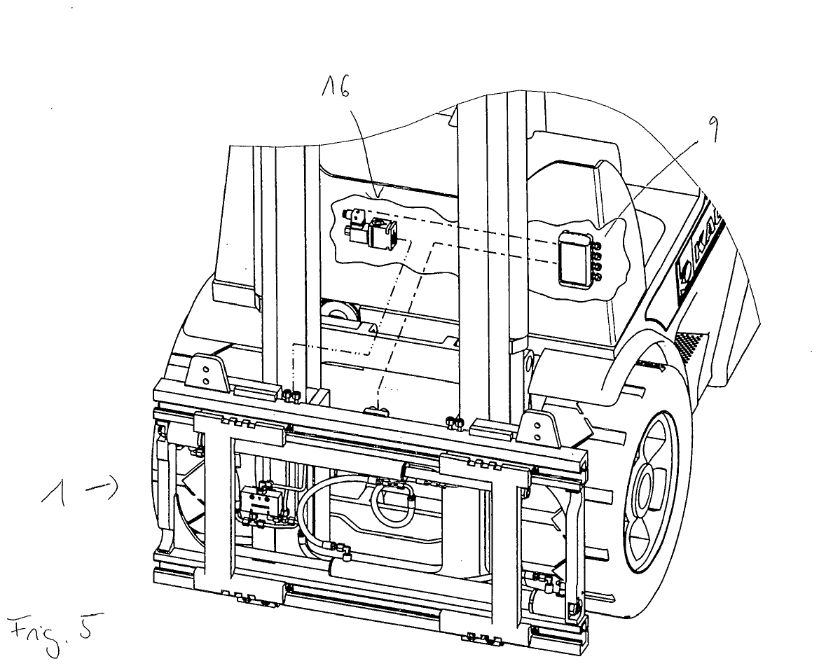

FIG. 5 shows the device 1 for transport on a lifting vehicle 3, the control means 9 and the valves 16 for the cylinders 13 being provided in the lifting vehicle 3.

### LIST OF REFERENCE NUMERALS

1 Device for transporting
2 transported good
3 lifting vehicle
4 means for at least temporarily receiving
5 adjusting means for lateral adjusting
6 lateral direction AC or BD
7 measuring means
8 lateral traverse path AC or BD
9 control means
10 sensor means
11 initial position
12 end position
13 cylinder
14 direction
15 predetermined length
16 valve
17 tine

1. Device (1) for transporting a transported good (2) for attachment to a lifting vehicle (3), in particular to a transport device (3) of a forklift truck, comprising a means (4), in particular tines, for at least temporarily receiving the transported goods (2), an adjusting means for adjusting the means (4) for at least temporarily receiving the transported goods (2) for parallel lateral adjustment, in particular of the tines, in the lateral direction (6), a control means (9) for controlling the functions of the attachment, the control means being arranged in particular in the lifting vehicle, a measuring means (7) for measuring a lateral traverse path (8) of the means (4) for at least temporarily picking up the transported goods (2), the lateral traverse path (8) being limited to a predetermined length (15) via the control means (9) and the adjusting means (5) with the aid of the measurement by means of the measuring means (7).

2. Device according to claim 1, characterized in that the measuring means (7) comprises a sensor means (10), in particular a mechanical sensor and/or an electrical sensor and/or a hydraulic sensor.

3. Device according to claim 1, characterized in that the measuring means (7) comprises a sensor means (10) provided corresponding to an initial position (11) and/or an end position (12) of the lateral parallel displacement of the means (4) and/or the displacement means (5) for the lateral displacement.

4. Device according to claim 1, characterized in that the measuring means (7) comprises an integrated sensor means, in particular integrated into the control means (9) and/or the adjustment means (5).

5. Device according to claim 1, characterized in that the adjusting means (5) for a lateral adjustment comprises a cylinder (13), in particular hydraulic and/or electric, in particular linear actuator, and/or mechanically driven, the cylinder (13) being arranged in particular parallel to the lateral direction (6), a control valve in particular being arranged in the lifting vehicle and/or in the device.

6. Device according to claim 1, characterized in that two adjusting means (5) are provided for a lateral adjustment, which are arranged in particular in opposite directions with opposite acting direction (14), wherein a parallel lateral adjustment is to be achieved.

7. A device according to claim 1, characterized in that the predetermined length (15) for a parallel lateral adjustment is predetermined by a maximum carrying capacity of the means for transport and/or a predetermined lifting height of the transported goods (2) and/or the weight of the transported goods (2) and/or a predetermined position of the means (4) for at least temporarily receiving the transported goods (2).

8. Device according to claim 1, characterized in that the control means (9) comprises a magnetic control and/or microPLC control.

9. Device according to claim 1, characterized in that the lateral travel path (8) for one side is limited to a permissible size, in particular about 200 mm, in particular about 100 mm.

10. Device according to claim 1, characterized in that the measuring means (7) are accommodated in the lifting vehicle

11. A method of using a device (1) for transporting a transported good for attachment to a lifting vehicle (3), according to claim 1, in particular to a transport device of a forklift truck, comprising a means (4), in particular tines, for at least temporarily picking up the transported good (2), an adjusting means (5) for a lateral adjustment of the means (4) for at least temporarily picking up the transported good (2) in the lateral direction (6), a measuring means (7) for measuring a lateral travel path (8) of the means (4) for at least temporarily receiving the transported goods (2), a control means (9) for controlling the lateral travel path (8) by means of the adjusting means (5) for a lateral adjustment, wherein the lateral travel path (8) is measured by means of the measuring means (7) and is limited to a predetermined length (15) via the control means (9) and the adjusting means (5), wherein the predetermined length in particular depends on a predetermined lifting height and/or a weight of the transported goods and/or a position of the transported goods.
